(19) United States
(12) Patent Application Publication
(10) Pub. No.: US 2006/0168661 A1
(43) Pub. Date: Jul. 27, 2006

(54) Apparatus and method to implement data management protocols using a projector

(76) Inventors: Richard V. Kisley, Tucson, AZ (US); John M. Lake, Cary, NC (US)

Correspondence Address: DALE F. REGELMAN, 4231 S. FREMONT AVENUE, TUCSON, AZ, 85714, US

(21) Appl. No.: 11/043,508

(22) Filed: Jan. 25, 2005

(51) Int. Cl. H04N 7/16; G06F 17/30; G03B 23/02

(52) U.S. Cl. 726/26; 353/25; 707/9

(57) ABSTRACT

A method is disclosed to implement data management protocols using a projector. The method provides first information comprising data and metadata to the projector, where that metadata comprises data management protocols for said first information. The method then determines by the projector if the data management protocols designate a time interval. If the data management protocols designate a time interval, then the method determines, by the projector, that time interval, the current time, and if the current time is within the time interval. If the current time is not within the time interval, then the method does not permit presentation of the first information using the projector. Alternatively, if the current time is within the time interval, then the method permits presentation of the first information using the projector.

### FIELD OF THE INVENTION

The invention relates to an apparatus and method to implement data management protocols using a projector. In certain embodiments, the invention relates to an apparatus and method to implement data management protocols using a network attached projector.

### BACKGROUND OF THE INVENTION

In the course of business, it is often necessary to give a live presentation using a projecting device, where that live presentation includes disclosing confidential information. It is often undesirable to recite such confidential information on one or more tangible objects, such as for example overhead transparencies, slides, and the like. In the event the content of such confidential information is revised, it may be difficult to update those tangible objects “on the road.” Moreover, proper disposal of the superceded objects may be difficult or impossible. In addition, safeguarding the security of those tangible objects, original, updated, superceded, and the like, remains a continuing burden.

Using a projector capable of accessing such confidential information via a communication link addresses many of the problems inherent with preparing and using tangible objects that recite such confidential information. What is needed, however, is a projector that implements one or more data management protocols to control access to such confidential information when that confidential information is stored on the projector.

### SUMMARY OF THE INVENTION

Applicants' invention comprises a method to implement data management protocols using a projector. The method provides first information comprising data and metadata to the projector, where that metadata comprises data management protocols for said first information. The method then determines by the projector if the data management protocols designate a time interval.

If the data management protocols designate a time interval, then the method determines, by the projector, that time interval, the current time, and if the current time is within the time interval. If the current time is not within the time interval, then the method does not permit presentation of the first information using the projector. Alternatively, if the current time is within the time interval, then the method permits presentation of the first information using the projector.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram of Applicants' projector;

FIG. 2 is a block diagram of a first embodiment of Applicants' network;

FIG. 3 is a block diagram of a second embodiment of Applicants' network;

FIG. 4 is a block diagram of a third embodiment of Applicants' network;

FIG. 5 is a flow chart summarizes the steps of Applicants' method; and

FIG. 6 is a flow chart summarizing certain additional steps of Applicants' method.

### DETAILED DESCRIPTION OF THE PREFERRED EMBODIMENTS

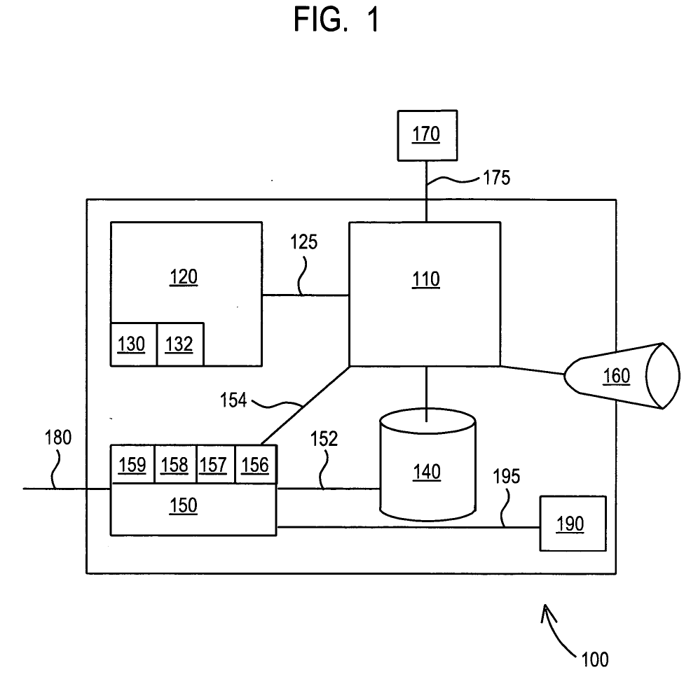

This invention is described in preferred embodiments in the following description with reference to the Figures, in which like numbers represent the same or similar elements. Referring now to FIG. 1, Applicants' projector 100 includes projector processor 110, memory 120, data cache 140, network interface 150, and light projecting device 160.

In certain embodiments, memory 120 comprises non-volatile memory, such as for example one or more EEPROMs (Electrically Erasable Programmable Read Only Memory), one or more flash PROMs (Programmable Read Only Memory), battery backup RAM, hard disk drive, one or more optical storage media (CD, DVD, and the like), combinations thereof, and the like.

Projector 100 further includes instructions/functions 130 and printer driver 132, written to memory 120. Projector processor 110 uses those instructions/functions 130 to operate the projector. In certain embodiments, instructions/functions 130 comprise microcode specific to projector 100. In other embodiments, instructions/functions 130 comprise a first operating system. By “operating system,” Applicants mean, where certain of those instructions/functions are disposed in a user mode portion and where other of those instructions/functions are disposed in a kernel mode portion. As those skilled in the art will appreciate, user applications may invoke certain functions disposed in the user mode portion, but may not, without receiving authorization, access functions disposed in the kernel mode portion.

Printer driver 132 comprises instructions/functions needed for operating system 130 to utilize Applicants' network attached projector 100 as an selectable printer utility. In embodiments wherein operating system 130 comprises Windows-based operating system (Windows is a registered trademark of Microsoft Corporation), the printer driver 132 is compatible with the Windows operating system used. In embodiments wherein operating system 130 comprises Linux (LINUX is a registered trademark owned by Linus Torvalds), then printer driver 132 is compatible with the Linux operating system used.

Network interface 150 includes interface processor 156, instructions/functions 157, memory 158, and network address 159. Interface processor 156 uses instructions/functions 157 to operate interface 150. In certain embodiments, interface processor 156 also comprises projector processor 110. In these embodiments, interface processor 156 uses instructions/functions 157 to operate network interface 150, and uses instructions/operating system 130 to operate projector 100.

Light projecting device 160 comprises an assembly which includes one or more light emitting devices, one or more optical lenses, and associated hardware, software, and circuitry to receive a signal from projector processor 110 via communication link 165, and then form and project a visible image based upon that signal.

Projector processor 110 is interconnected with memory 120, data cache 140, and network interface 150 via communication links 125, 145, and 154, respectively. In certain embodiments, data cache is interconnected with network interface 150 via communication link 152.

In certain embodiments, projector 100 further includes data input device 170. In certain embodiments, data input device 170 comprises a computing device which includes a monitor, keyboard, a second operating system, and the like. In certain embodiments, the first operating system and the second operating system are the same. In other embodiments, the first operating system differs from the second operating system.

In certain embodiments, data input device 170 comprises a hand-held device which includes a plurality of individual touch screens, buttons, switches, and the like, with which an operator can control certain functions of projector 100. For example, in one embodiment device 170 comprises a hand-held device with which an operator can instruct projector 100 to display a desired image.

In certain embodiments, projector 100 further includes global positioning satellite (“GPS”) device 190. By “GPS device,” Applicants mean a device capable of receiving a plurality of signals from a plurality of GPS satellites, in combination with associated hardware, software, and circuitry to determine the geographical position of the device using that plurality of received signals.

Network interface 150 is interconnected with one or more computing devices via communication link 180. Communication link 180 is selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, communication link 180 is compliant with one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example projector 100, and a base station or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or Wi-Fi, which comprises an extension to 802.11 that applies to wireless LANS and provides up to about 11 Mbps transmission in the 2.4 GHz band; and/or (iv) specification 802.11g which applies to wireless LANs and provides 20+ Mbps in the 2.4 GHz band.

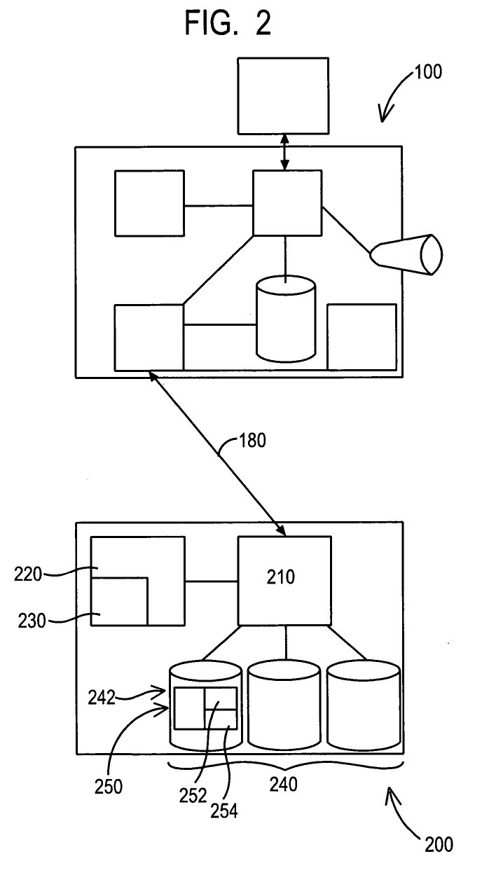

Referring now to FIG. 2, in certain embodiments projector 100 is capable of communicating with computing device 200 via communication link 180. In certain embodiments, computing device 200 includes, without limitation, a processor 210, memory 220, operating system 230, and a plurality of information storage media 240 in combination with associated information storage devices. In certain embodiments, information storage media 240 include, without limitation hard disks disposed in hard disk drives, portable cassettes comprising magnetic tape storage media and the associated tape drive units, optical storage media and the associated optical disk drive units, RAM, DASDs, combinations thereof, and the like.

In certain embodiments of Applicants' apparatus and method, computing device 200 includes a unique directory, such as directory 250. By “unique,” Applicants mean a directory to which access is controlled. In the illustrated embodiment of FIG. 2, directory 250 includes first information 252 and first information metadata 254.

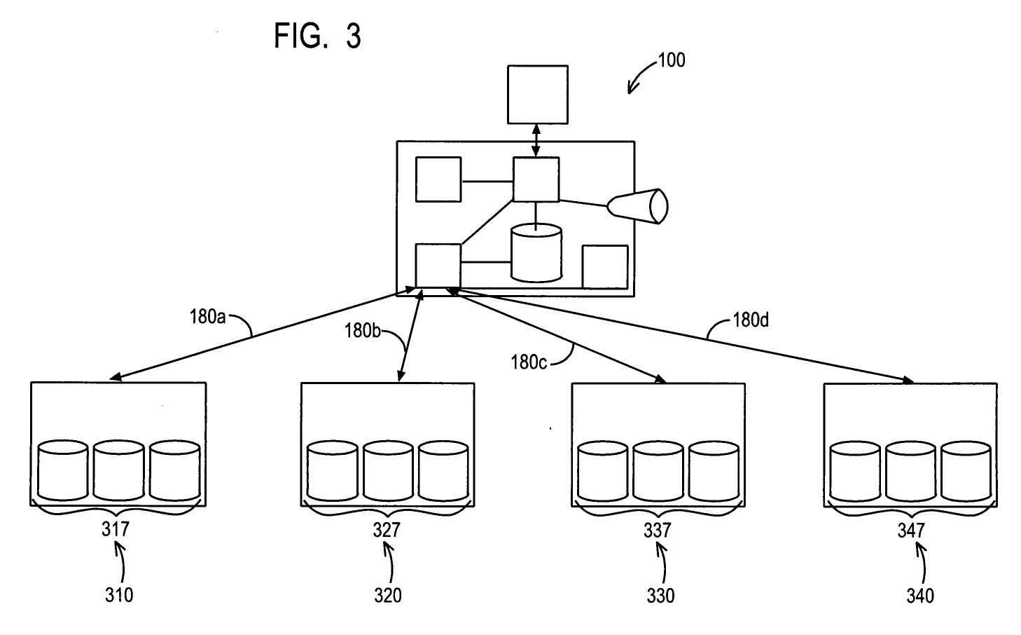

Referring now to FIG. 3, in certain embodiments Applicants' apparatus includes a plurality of servers, such as for example servers 310, 320, 330, and 340, wherein those servers include plurality of storage media/storage devices 317, 327, 337, and 347, respectively, where those storage media/storage devices are as described above with respect to storage media/storage device 240 (FIG. 2). In certain embodiments, one or more of servers 310, 320, 330, and 340, comprise computing devices. In certain embodiments, those one or more computing devices comprise computing device 200 (FIG. 2).

Server 310 is capable of communicating with Applicants' projector 100 (FIG. 1) via communication link 180a. Server 320 is capable of communicating with Applicants' projector 100 via communication link 180b. Server 330 is capable of communicating with Applicants' projector 100 via communication link 180c. Server 340 is capable of communicating with Applicants' projector 100 via communication link 180d. The illustrated embodiment of FIG. 3 shows four servers capable of communicating with projector 100. In other embodiments, Applicants' apparatus includes fewer than four servers capable of communicating with projector 100. In still other embodiments, Applicants' apparatus includes more than four servers capable of communicating with projector 100.

Communication links 180a, 180b, 180c, 180d, are each independently selected from the group which includes a wireless communication link, a wireless communication link compliant with the IEEE Specification, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

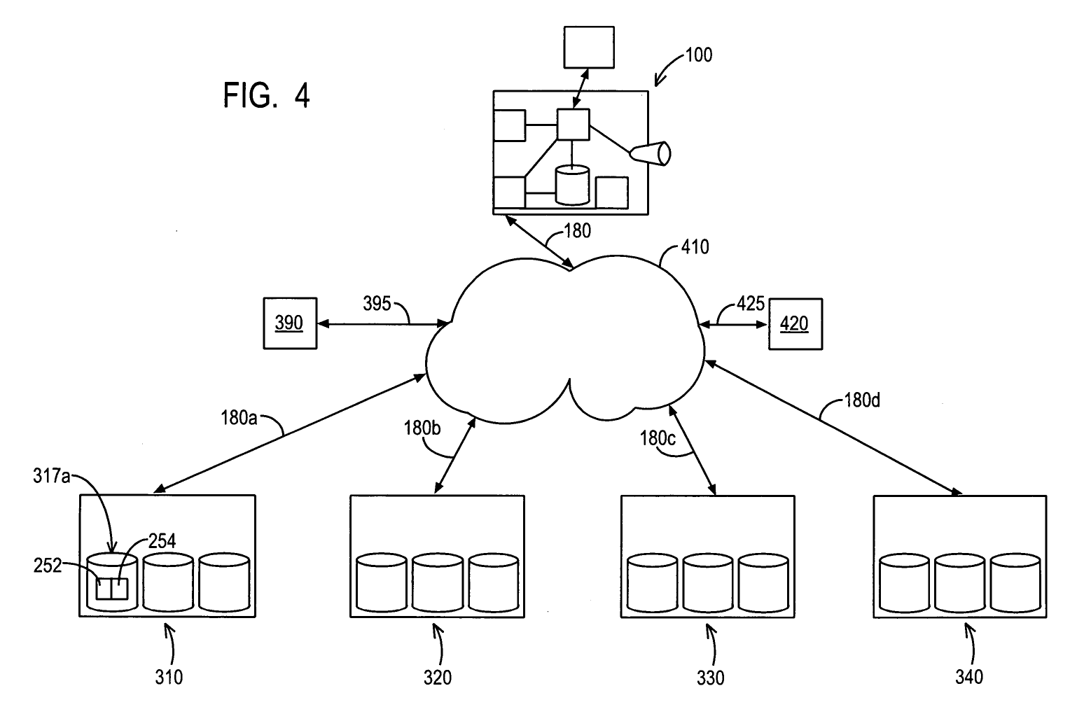

Referring now to FIG. 4, in certain embodiments Applicants' apparatus includes projector 100 (FIGS. 1, 2, 3, 4), server 310 (FIGS. 3, 4), server 320 (FIGS. 3, 4), server 330 (FIGS. 3, 4), and server 340 (FIGS. 3, 4), storage attached network (“SAN”) 410, and computing device 390. In certain embodiments, computing device 390 comprises what is sometimes referred to as a host computer. Computing device 390 comprises a computer system, such as a mainframe, personal computer, workstation, and combinations thereof, including an operating system such as Windows, AIX, Unix, MVS, LINUX, etc. AIX is a registered trademark and MVS is a trademark of IBM Corporation; UNIX is a registered trademark in the United States and other countries licensed exclusively through The Open Group. In certain embodiments, computing device 390 further includes a storage management program. The storage management program in the computing device 390 may include the functionality of storage management type programs known in the art that manage the transfer of data to and or from servers 310, 320, 330, and/or 340, and to and/or from projector 100, such as the IBM DFSMS implemented in the IBM MVS operating system

As those skilled in the art will appreciate, a SAN comprises a dedicated network that connects one or more hosts, such as computing device 390, one or more projectors, such as projector 100, and one or more storage devices and subsystems, such as servers 310, 320, 330, and/or 340. In certain embodiments, SAN 410 includes an appliance, such as a networked attached storage device (“NASD”) 420.

NASD 420 comprises storage elements or devices that connect to a network and provide file access services to, for example, projector 100. NASD 420 attaches directly to networks, such as local area networks, using traditional protocols such as Ethernet and TCP/IP, and serve files to one or more clients, such as for example projector 100, connected to the network. In certain embodiments, NASD 420 includes an engine, which implements the file access services. A client that accesses a NASD typically uses a file system device driver to access the stored data. The file system device driver typically implements file access commands. The file system driver disposed in a NASD interprets these commands and performs the internal device input/output (I/O) operations necessary to execute those file access commands.

The illustrated embodiment of FIG. 4 shows four servers capable of communicating with projector 100 via SAN 410. In other embodiments, Applicants' apparatus includes fewer than four servers capable of communicating with projector 100 via SAN 410. In still other embodiments, Applicants' apparatus includes more than four servers capable of communicating with projector 100 via SAN 410.

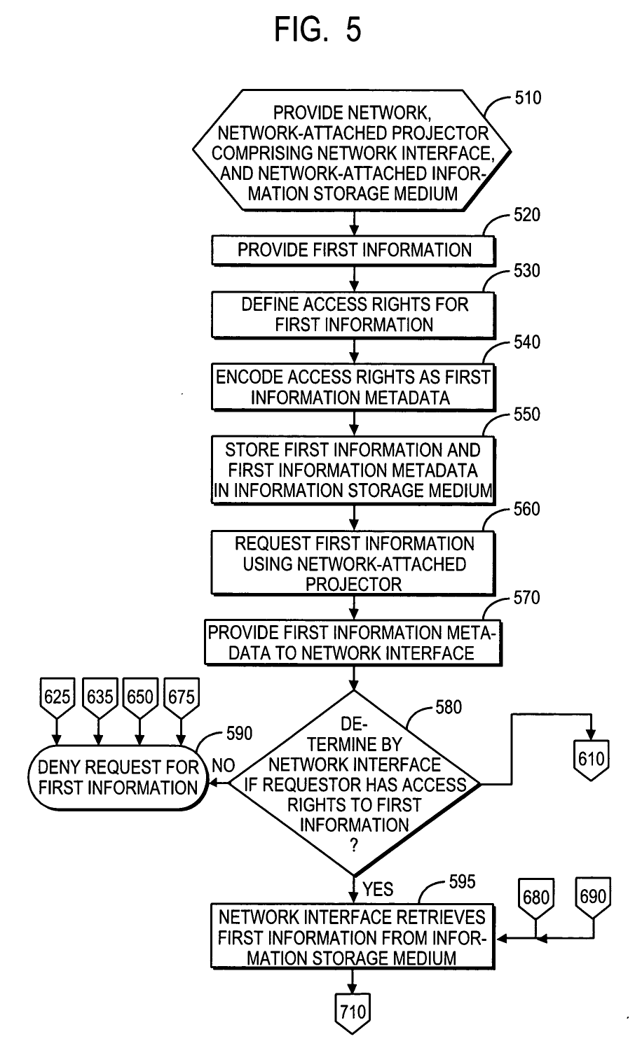

Applicants' invention includes a method to verify access rights using Applicants' projector. Referring now to FIG. 5, in step 510 Applicants' method provides a projector, such as for example Applicants' projector 100 (FIGS. 1, 2, 3, 4), and an information storage medium comprising confidential information, such as for example information storage medium 242 (FIG. 2) and/or storage medium 317a (FIG. 4), having first information 252 (FIGS. 2, 4) written thereto, wherein that projector is capable of communicating with that information storage medium via one or more communication links, such as for example communication link 180 and/or 180a.

In step 520, Applicants' method provides first information, such as for example first information 252 (FIGS. 2, 4). First information 252 comprises one or more datasets. In certain embodiments, those one or more datasets comprise, for example, one or more text documents. In certain embodiments, those one or more datasets comprise, for example, one or more images. In certain embodiments, those one or more datasets comprise, for example, one or more text documents in combination one or more images. In certain embodiments, those one or more datasets comprise, for example, one or more Microsoft Power Point presentations. In certain embodiments, those one or more datasets comprise, for example, one or more Lotus Freelance Graphics presentations. In certain embodiments, those one or more datasets comprise, for example, one or more Lotus Notes presentations.

In step 530, Applicants' method defines access rights for the first information provided in step 520. In certain embodiments, step 530 is performed by a processor, such as processor 220. In certain embodiments, step 530 is performed by one or more natural persons.

In certain embodiments, step 530 includes assigning a password for access to the first information. In certain embodiments, step 530 includes defining a specified time interval. In certain embodiments, step 530 includes defining a specified network address In certain embodiments, step 530 includes defining a specified geographical location.

In step 540, Applicants' method encodes the access rights defined in step 530 as first information metadata, such as first information metadata 254 (FIGS. 2, 4). In certain embodiments, that first information metadata includes a password. In certain embodiments, that first information metadata includes a specified time interval. In certain embodiments, that first information metadata includes a specified network address. In certain embodiments, that first information metadata includes a specified geographical location.

In step 550, Applicants' method writes the first information of step 520, and the first information metadata of step 540, to the information storage medium of step 510, such as for example information storage medium 242 (FIG. 2) or information storage medium 317a (FIG. 4). In certain embodiments, information storage medium 242 and/or 317a is disposed in a computing device, such as for example computing device 200 or 310, respectively. In these embodiments, step 550 is performed by a processor, such as for example processor 220 (FIG. 2), disposed in that computing device.

In step 560, a user requests the first information using the projector of step 510. In certain embodiments, the request of step 560 is made by a natural person using data input device 170 (FIG. 1). In certain embodiments, the request of step 560 is made by a processor disposed within the requesting projector, such as for example processor 120 (FIG. 1).

In certain embodiments, step 560 includes using a Windows-based application, such as for example PowerPoint. In these embodiments, the projector user first selects a the file comprising first information 252. In these embodiments, first information 252 is neither provided nor displayed at this time. The projector user then selects a print function and designates the network attached projector as the selected printing device.

In certain embodiments, step 560 includes using a Linux “lpr” command having the format:

lpr [-E] [-P destination] [-# num-copies] [-option] [-r] [job name] [file] wherein the -E designator forces encryption when connecting to a server, the -P destination comprises the network attached projector, the number of copies is set to 1, the -r option specifies that the named print files should be deleted after printing, i.e. after displaying the first information, and the file comprises the first information.

In embodiments wherein step 560 includes using a Windows-based print utility or a Linux-based print utility, Applicants' method includes installing printer driver 132 at any time prior to using a Windows/Linux print utility in step 560.

In step 570, Applicants' method provides the first information metadata, such as first information metadata 254, to projector 100, where that first information metadata 254 is received by network interface 150. In certain embodiments, step 570 is performed by Applicants' network attached projector, such as projector 100. In certain embodiments, step 570 is performed by a network interface, such as network interface 150, disposed within Applicants' network attached projector. In certain embodiments, step 570 is performed by a processor, such as interface processor 156, disposed within Applicants' network interface, such as network interface 150.

In step 580, the network interface, such as network interface 150, disposed within the requesting projector, such as projector 100, using first information metadata, such as first information metadata 254, determines if the requester of step 560 has access rights to first information 252. In certain embodiments, step 580 is performed by Applicants' network attached projector, such as projector 100. In certain embodiments, step 580 is performed by a network interface, such as network interface 150, disposed within Applicants' network attached projector. In certain embodiments, step 580 is performed by a processor, such as interface processor 156, disposed within Applicants' network interface, such as network interface 150.

In certain embodiments, step 580 includes determining if the first information metadata includes a password. In the event the first information metadata includes a password, in certain embodiments of Applicants' method step 580 further includes querying the projector user by the network interface for a password. In certain embodiments, step 580 further includes entering a password using user interface 170.

If Applicants' method determines in step 580 that the requestor making the request of step 560 has access rights to the first information of step 520, then the method transitions from step 580 to step 595 wherein the method provides that first information to the projector of step 510. In certain embodiments, step 595 is performed by Applicants' network attached projector, such as projector 100. In certain embodiments, step 595 is performed by a network interface, such as network interface 150, disposed within Applicants' network attached projector. In certain embodiments, step 595 is performed by a processor, such as interface processor 156, disposed within Applicants' network interface, such as network interface 150.

If Applicants' method determines in step 580 that the requestor making the request of step 560 does not have access rights to the requested confidential information, then Applicants' method transitions from step 580 to step 590 wherein the method denies the request for access to the first information. In certain embodiments, step 590 is performed by a processor, such as interface processor 156 (FIGS. 1,2), disposed in a network interface, such as network interface 150 (FIG. 1).

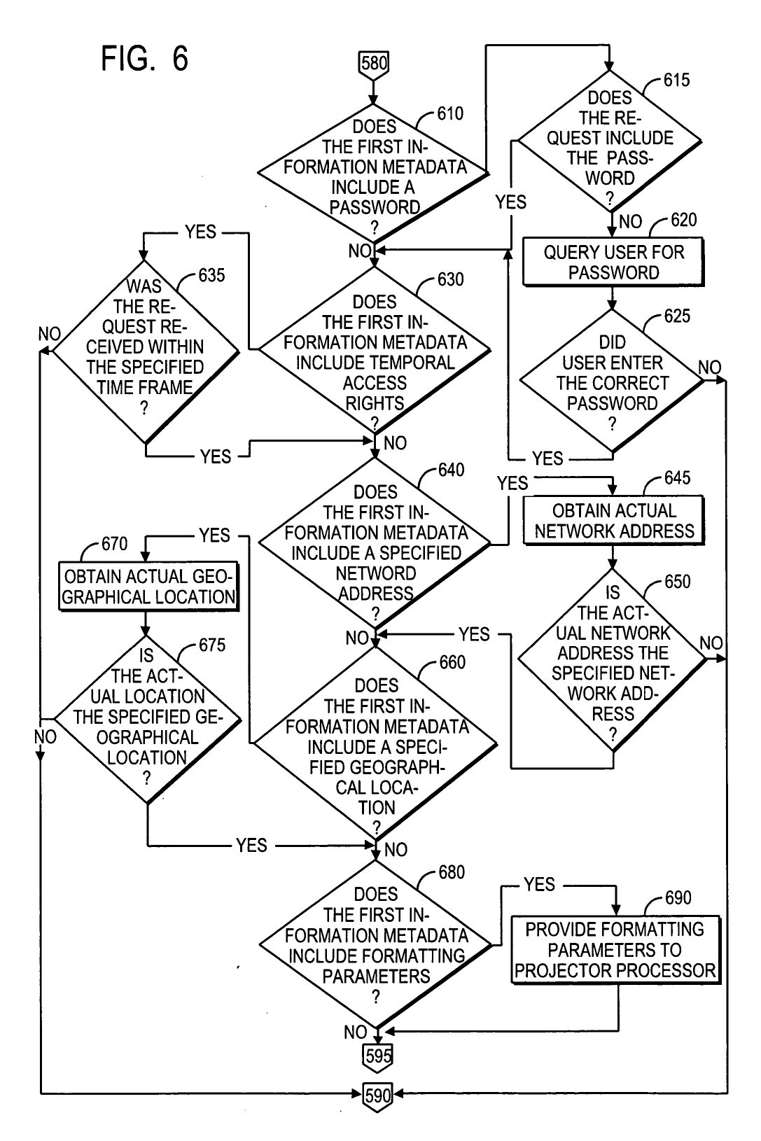

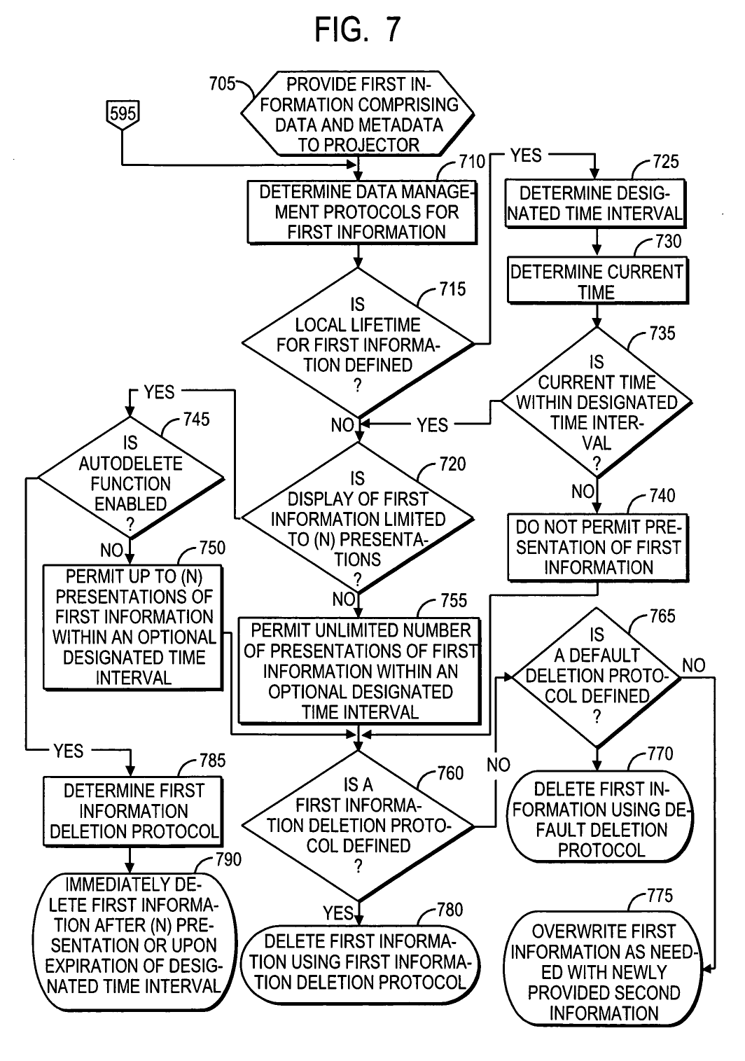

In certain embodiments, step 580 includes the steps recited in FIG. 6. Referring now to FIG. 6, in step 610 Applicants' method determines if the first information metadata includes a password. In certain embodiments, step 610 is performed by Applicants' network attached projector, such as projector 100. In certain embodiments, step 610 is performed by a network interface, such as network interface 150, disposed within Applicants' network attached projector. In certain embodiments, step 610 is performed by a processor, such as interface processor 156, disposed within Applicants' network interface, such as network interface 150.

If Applicants' method determines in step 610 that the first information metadata does not include a password, then the method transitions from step 610 to step 630. Alternatively, if Applicants' method determines in step 610 that the first information metadata does include a password, then the method transitions from step 610 to step 615 wherein the method determines if the request of step 560 includes the correct password.

In certain embodiments, step 615 is performed by Applicants' network attached projector, such as projector 100. In certain embodiments, step 615 is performed by a network interface, such as network interface 150, disposed within Applicants' network attached projector. In certain embodiments, step 615 is performed by a processor, such as interface processor 156, disposed within Applicants' network interface, such as network interface 150.

If Applicants' method determines in step 615 that the request of step 560 includes the correct password, then the method transitions from step 615 to step 630. Alternatively, if Applicants' method determines in step 615 that the request of step 560 does not include the correct password, then the method transitions from step 615 to step 620 wherein the method queries the user for a password.

In certain embodiments, step 620 is performed by Applicants' network attached projector, such as projector 100. In certain embodiments, step 620 is performed by a network interface, such as network interface 150, disposed within Applicants' network attached projector. In certain embodiments, step 620 is performed by a processor, such as interface processor 156, disposed within Applicants' network interface, such as network interface 150.

Applicants' method transitions from step 620 to step 625, wherein the method determines if the user entered the correct password. If Applicants' method determines in step 625 that the user entered the correct password, then the method transitions from step 625 to step 630. Alternatively, if the method determines in step 625 that the user did not enter the correct password, then the method transitions from step 625 to step 590.

In certain embodiments, step 625 is performed by Applicants' network attached projector, such as projector 100. In certain embodiments, step 625 is performed by a network interface, such as network interface 150, disposed within Applicants' network attached projector. In certain embodiments, step 625 is performed by a processor, such as interface processor 156, disposed within Applicants' network interface, such as network interface 150.

In step 630, Applicants' method determines if the first information metadata includes a specified time interval. In certain embodiments, step 630 is performed by Applicants' network attached projector, such as projector 100. In certain embodiments, step 630 is performed by a network interface, such as network interface 150, disposed within Applicants' network attached projector. In certain embodiments, step 630 is performed by a processor, such as interface processor 156, disposed within Applicants' network interface, such as network interface 150.

If Applicants' method determines in step 630 that the first information metadata does not include a specified time interval, then the method transitions from step 630 to step 640. Alternatively, if Applicants' method determines in step 630 that the first information metadata does include a specified time interval, then the method transitions from step 630 to step 635 wherein the method determines if the request of step 560 was received within the specified time interval. In certain embodiments, step 635 is performed by Applicants' network attached projector, such as projector 100. In certain embodiments, step 635 is performed by a network interface, such as network interface 150, disposed within Applicants' network attached projector. In certain embodiments, step 635 is performed by a processor, such as interface processor 156, disposed within Applicants' network interface, such as network interface 150.

If Applicants' method determines in step 635 that the request of step 560 was received within the specified time interval, then the method transitions from step 635 to step 640. Alternatively, if Applicants' method determines in step 635 that request of step 560 was received not within the specified time interval, then the method transitions from step 635 to step 590.

In step 640, Applicants' method determines if the first information metadata includes a specified network address. In certain embodiments, step 640 is performed by Applicants' network attached projector, such as projector 100. In certain embodiments, step 640 is performed by a network interface, such as network interface 150, disposed within Applicants' network attached projector. In certain embodiments, step 640 is performed by a processor, such as interface processor 156, disposed within Applicants' network interface, such as network interface 150.

If Applicants' method determines in step 640 that the first information metadata does not include a specified network address, then the method transitions from step 640 to step 660. Alternatively, if Applicants' method determines in step 640 that the first information metadata does include a specified network address, then the method transitions from step 640 to step 645 wherein the method obtains the actual network address, such as for example network address 159 (FIG. 1).

In certain embodiments, step 645 is performed by Applicants' network attached projector, such as projector 100. In certain embodiments, step 645 is performed by a network interface, such as network interface 150, disposed within Applicants' network attached projector. In certain embodiments, step 645 is performed by a processor, such as interface processor 156, disposed within Applicants' network interface, such as network interface 150.

Applicants' method transitions from step 645 to step 650 wherein the method determines if the actual network address is the specified network address. In certain embodiments, step 650 is performed by Applicants' network attached projector, such as projector 100. In certain embodiments, step 650 is performed by a network interface, such as network interface 150, disposed within Applicants' network attached projector. In certain embodiments, step 650 is performed by a processor, such as interface processor 156, disposed within Applicants' network interface, such as network interface 150.

If Applicants' method determines in step 650 that the actual network address is the specified network address, then the method transitions from step 650 to step 660. Alternatively, if Applicants' method determines in step 650 that the actual network address is not the specified network address, then the method transitions from step 650 to step 590.

In step 660, Applicants' method determines if the first information metadata includes a specified geographical location. In certain embodiments, step 660 is performed by Applicants' network attached projector, such as projector 100. In certain embodiments, step 640 is performed by a network interface, such as network interface 150, disposed within Applicants' network attached projector. In certain embodiments, step 640 is performed by a processor, such as interface processor 156, disposed within Applicants' network interface, such as network interface 150.

If Applicants' method determines in step 660 that the first information metadata does not include a specified geographical location, then the method transitions from step 660 to step 680. Alternatively, if Applicants' method determines in step 660 that the first information metadata does include a specified geographical location, then the method transitions from step 660 to step 670 wherein the method obtains the actual geographical location from an GPS component disposed in the requesting network attached projector, such as GPS component 190 (FIG. 1) disposed in Applicants' network attached projector 100.

In certain embodiments, step 670 is performed by Applicants' network attached projector, such as projector 100. In certain embodiments, step 670 is performed by a network interface, such as network interface 150, disposed within Applicants' network attached projector. In certain embodiments, step 670 is performed by a processor, such as interface processor 156, disposed within Applicants' network interface, such as network interface 150.

Applicants' method transitions from step 670 to step 675 wherein the method determines if the actual geographical location is the specified geographical location. In certain embodiments, step 675 is performed by Applicants' network attached projector, such as projector 100. In certain embodiments, step 675 is performed by a network interface, such as network interface 150, disposed within Applicants' network attached projector. In certain embodiments, step 675 is performed by a processor, such as interface processor 156, disposed within Applicants' network interface, such as network interface 150.

If Applicants' method determines in step 675 that the actual geographical location is the specified geographical location, then the method transitions from step 675 to step 680. Alternatively, if Applicants' method determines in step 675 that the actual geographical location is not the specified geographical location, then the method transitions from step 675 to step 590.

In step 680, Applicants' method determines if the first information metadata includes one or more formatting parameters. In certain embodiments, step 680 is performed by Applicants' network attached projector, such as projector 100. In certain embodiments, step 680 is performed by a network interface, such as network interface 150, disposed within Applicants' network attached projector. In certain embodiments, step 680 is performed by a processor, such as interface processor 156, disposed within Applicants' network interface, such as network interface 150.

If Applicants' method determines in step 680 that the first information metadata does not include one or more formatting parameters, then the method transitions from step 680 to step 595. On the other hand, if Applicants' method determines in step 680 that the first information metadata includes one or more formatting parameters, then the method transitions from step 680 to step 690 wherein the method provides those one or more formatting parameters to the projector processor, such as projector processor 110, disposed within Applicants' projector, such as projector 100. Applicants' method transitions from step 690 to step 595.

In certain embodiments, step 595 further comprises writing the first information retrieved in step 595 to an information storage medium disposed in Applicants' projector. In certain embodiments, step 595 comprises writing the first information retrieved in step 595 to data cache 140. In certain embodiments, data cache 140 comprises a direct access data storage device (“DASD”). In other embodiments, data cache 140 comprises a magnetic data storage medium and associated data drive hardware. In yet other embodiments, data cache 140 comprises an optical storage medium and associated data drive hardware. In still other embodiments, data cache 140 comprises an electronic storage medium.

Applicants' method further includes one or more data management protocols to manage confidential information, such as for example the first information stored in data cache 140 in step 595. FIG. 7 summarizes Applicants' data management protocols.

In step 705, Applicants' method provides first information comprising data and metadata to Applicants' projector, such as projector 100. In certain embodiments, Applicants' method transitions from step 705 to step 710. In other embodiments, Applicants' method transitions from step 595 (FIG. 5) to step 710 wherein the method determines data management protocols for the first information provided in step 595 or step 705. In certain embodiments, step 710 comprises reading the metadata of step 540 or step 705. In certain embodiments, step 710 is performed by a projector controller, such as controller 110 (FIG. 1).

Applicants' method transitions from step 710 to step 715 wherein the method determines if the data management protocols of step 710 define a local lifetime for the first information received in step 595 or step 705. In certain embodiments, step 715 is performed by a projector controller, such as controller 110 (FIG. 1).

If Applicants' method determines in step 715 that the data management protocols of step 710 do not define a local lifetime for the first information received in step 595 or step 705, then the method transitions from step 715 to step 720. Alternatively, if Applicants' method determines in step 715 that the data management protocols of step 710 define a local lifetime for the first information received in step 595 or step 705, then the method transitions from step 715 to step 725 wherein the method determines the designated time interval during which the first information may be presented using Applicants' projector. In certain embodiments, step 725 is performed by a projector controller, such as controller 110 (FIG. 1).

Applicants' method transitions from step 725 to step 730 wherein the method determines the current time. In certain embodiments, step 730 further comprises determining the current date and time using network interface 150, communication link 180, and a time source external to projector 100. In certain embodiments, step 730 further comprises determining the current date and time using signals received by GPS 190. In other embodiments, Applicants' projector 100 comprises hardware and/or software which is capable of determining the current date and time.

Applicants' method transitions from step 730 to step 735 wherein the method determines if the current time is within the designated time interval determined in step 725. In certain embodiments, step 725 is performed by a projector controller, such as controller 110 (FIG. 1).

If Applicants' method determines in step 735 that the current time is not within the designated time interval, then the method transitions from step 735 to step 740 wherein the method does not permit presentation of the first information using Applicants' projector. In certain embodiments, step 740 is performed by a projector controller, such as controller 110 (FIG. 1). Applicants' method transitions from step 740 to step 760.

Alternatively, if Applicants' method determines in step 735 that the current time is within the designated time interval, then the method transitions from step 735 to step 720 wherein the method determines if the data management protocols determined in step 710 limit the display of first information to (N) presentations. In certain embodiments, (N) is 1. In these (N) equals 1 embodiments, Applicants' projector will only permit a single presentation of the first information. In other embodiments, (N) is greater than 1. In certain embodiments, step 720 is performed by a projector controller, such as controller 110 (FIG. 1).

If Applicants' method determines in step 720 that the data management protocols determined in step 710 do not limit the display of first information to (N) presentations, then the method transitions from step 720 to step 755 wherein Applicants' method permits an unlimited number of presentations of the first information. If the data management protocols for the first information specify a designated time interval, then in step 755 Applicants' method permits an unlimited number of presentations of first information within that designated time interval. In the event the projector is displaying first information at the expiration of the designated time interval, then that presentation of first information is immediately terminated. In certain embodiments, step 755 is performed by a projector controller, such as controller 110 (FIG. 1). Applicants' method transitions from step 755 to step 760.

Alternatively, if Applicants' method determines in step 720 that the data management protocols determined in step 710 limit the display of first information to (N) presentations, then the method transitions from step 720 to step 745 wherein the method determines if an autodelete function is enabled. In certain embodiments, step 745 is performed by a projector controller, such as controller 110 (FIG. 1).

If Applicants' method determines in step 745 that an autodelete function is enabled, then the method transitions from step 745 to step 785 wherein the method determines the specified first information deletion protocol. Applicants' method transitions from step 785 to step 790 wherein the method deletes the first information from the projector using the autodelete function specified in the data management protocols for the first information. In certain embodiments, step 790 is performed by a projector controller, such as controller 110 (FIG. 1).

In certain embodiments of Applicants' autodelete function, an entire presentation comprising (M) individual display screens is automatically deleted after (N) presentations of the first information or upon the expiration of a designated time interval.

In other embodiments, of Applicants' autodelete function, the (i)th display screen is automatically deleted after that display screen has been presented (N) times. For example where (N) is 1, Applicants' method displays the first screen one time. When the presentation transitions to the second display screen, Applicants' method automatically deletes the first information comprising the first display screen. Where the first information comprises (M) individual display screens, the first information comprising the (i)th display screen is automatically deleted as the (i+1)th display screen is presented. At the conclusion of the first and only presentation of the first information, i.e. where (i) equals (M), the first information comprising that (M)th display screen is automatically deleted.

If Applicants' method determines in step 745 that an autodelete function is not enabled, then the method transitions from step 745 to step 750 wherein the method permits up to (N) presentations of the first information. In certain embodiments, step 750 is performed by a projector controller, such as controller 110 (FIG. 1). If the data management protocols for the first information specify a designated time interval, then in step 750 Applicants' method permits up to (N) presentations of first information within that designated time interval. In the event the projector is displaying first information at the expiration of the designated time interval, then that presentation of first information is immediately terminated.

Applicants' method transitions from step 750 to step 760 wherein the method determines if the data management protocols for the first information comprise a first information deletion protocol. In certain embodiments, step 760 is performed by a projector controller, such as controller 110 (FIG. 1). If Applicants' method determines in step 760 that the data management protocols for the first information comprise a first information deletion protocol, then the method transitions from step 760 to step 780 wherein the method deletes the first information from Applicants' projector using the first information deletion protocol. In certain embodiments, step 780 is performed by a projector controller, such as controller 110 (FIG. 1).

In certain embodiments, the first information deletion protocol comprises overwriting the first information with zeros. In other embodiments, the first information deletion protocol comprises active destruction of the individual bits comprising the first information.

If Applicants' method determines in step 760 that the data management protocols for the first information do not comprise a first information deletion protocol, then the method transitions from step 760 to step 765 wherein the method determines if a default deletion protocol is defined for the projector. In certain embodiments, step 765 is performed by a projector controller, such as controller 110 (FIG. 1). In certain embodiments, such a default deletion protocol is stored in instructions/functions 130 (FIG. 1).

If Applicants' method determines in step 765 that a default deletion protocol is defined for the projector, then the method transitions from step 765 to step 770 wherein the method deletes the first information from the projector using the default deletion protocol. In certain embodiments, step 770 is performed by a projector controller, such as controller 110 (FIG. 1).

Alternatively, if Applicants' method determines in step 765 that a default deletion protocol is not defined for the projector, then the method transitions from step 765 to step 775 wherein the method overwrites the first information as needed when storing second information, i.e. one or more newly-acquired files. In certain embodiments, step 775 is performed by a projector controller, such as controller 110 (FIG. 1).

The embodiments of Applicants' method recited in FIGS. 5, and/or 6, and/or 7, may be implemented separately. Moreover, in certain embodiments, individual steps recited in FIGS. 5, and/or 6, and/or 7, may be combined, eliminated, or reordered.

In certain embodiments, Applicants' invention includes instructions, such as instructions 130 (FIG. 1) and/or instructions 157 (FIG. 1), where those instructions are executed by processor 110 (FIG. 1) and/or processor 156 (FIG. 1), to perform step 560 which includes receiving a request for access, step 570 which includes receiving first information metadata, and steps 580, 590, and 595, recited in FIG. 5, and/or steps 610 through 690, inclusive, recited in FIG. 6, and/or steps 710 through 790, inclusive, recited in FIG. 7.

In other embodiments, Applicants' invention includes instructions residing in any other computer program product, where those instructions are executed by a computer external to, or internal to, projector 100 to perform step 560 which includes receiving a request for access, step 570 which includes receiving first information metadata, and steps 580, 590, and 595, recited in FIG. 5, and/or steps 610 through 690, inclusive, recited in FIG. 6, and/or steps 710 through 790, inclusive, recited in FIG. 7. In either case, the instructions may be encoded in an information storage medium comprising, for example, a magnetic information storage medium, an optical information storage medium, an electronic information storage medium, and the like. By “electronic storage medium,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to implement data management protocols using a projector, comprising the steps of:
supplying a projector;
providing first information comprising data and metadata to said projector, wherein said metadata comprises data management protocols for said first information;
determining by said projector if said data management protocols designate a time interval;
operative if said data management protocols designate a time interval, determining that time interval;
determining the current time;
determining by said projector if said current time is within said time interval;
operative if said current time is not within said time interval, not permitting presentation of said first information using said projector;
operative if said current time is within said time interval, permitting presentation of said first information using said projector.

2. The method of claim 1, further comprising the steps of:
determining if said data management protocols limit the display of first information to (N) presentations;
operative if said data management protocols limit the display of first information to (N) presentations, permitting up to (N) presentations of said first information using said projector.

3. The method of claim 1, further comprising the steps of:
determining if said data management protocols comprise a first information deletion protocol;
operative if said data management protocols comprise a first information deletion protocol, deleting said first information from said projector using said first information deletion protocol.

4. The method of claim 3, wherein said projector further comprises a memory comprising instructions, further comprising the steps of:
operative if said data management protocols do not comprise a first information deletion protocol, determining if said instructions comprise a default deletion protocol;
operative if said instructions comprise a default deletion protocol, deleting said first information from said projector using said default deletion protocol.

5. The method of claim 4, further comprising the steps of:
writing said first information to said memory;
receiving second information;
operative if said instructions do not comprise a default deletion protocol, overwriting said first information with said second information.

6. The method of claim 3, further comprising the steps of:
determining if said first information deletion protocol comprises an autodelete function after (N) presentations of said first information;
operative if said first information deletion protocol comprises an autodelete function after (N) presentations of said first information, deleting said first information from said projector after (N) presentations of said first information.

7. The method of claim 6, wherein said projector further comprises an information storage medium, further comprising the steps of:
writing said first information to said information storage medium;
wherein said deleting said first information step further comprises overwriting said first information with zeros.

8. The method of claim 6, wherein said projector further comprises an information storage medium, and wherein said first information comprises a plurality of bits further comprising the steps of:
writing said plurality of bits to said information storage medium;
wherein said deleting said first information step further comprises destroying said plurality of bits.

9. The method of claim 1, wherein said supplying a projector step further comprises supplying a projector comprising a network interface, said method further comprising the steps of:
providing a communication link capable of communicating with said network interface;
providing an information storage medium comprising first information, wherein said network interface is capable of communicating with said information storage medium via said communication link;
defining access rights for said first information;
determining by said network interface if said projector has access rights to said first information;
operative if said projector has access rights to said first information, providing said first information to said projector;
operative if said projector does not have access rights to said first information, not providing said first information to said projector.

10. The method of claim 9, further comprising the steps of:
forming said first information metadata which comprises said access rights;
writing said first information metadata to said information storage medium; and
providing said first information metadata to said network interface.

11. A projector comprising a controller and a computer useable medium having computer readable program code disposed therein to implement data management protocols, the computer readable program code comprising a series of computer readable program steps to effect:
receiving first information comprising data and metadata, wherein said metadata comprises data management protocols for said first information;
determining if said data management protocols designate a time interval;
operative if said data management protocols designate a time interval, determining that time interval;
determining the current time;
determining if said current time is within said time interval;
operative if said current time is not within said time interval, not permitting presentation of said first information using said projector;
operative if said current time is within said time interval, permitting presentation of said first information using said projector

12. The projector of claim 11, said computer readable program code further comprising a series of computer readable program steps to effect:
determining if said data management protocols limit the display of first information to (N) presentations;
operative if said data management protocols limit the display of first information to (N) presentations, permitting up to (N) presentations of said first information using said projector.

13. The projector of claim 11, said computer readable program code further comprising a series of computer readable program steps to effect:
determining if said data management protocols comprise a first information deletion protocol;
operative if said data management protocols comprise a first information deletion protocol, deleting said first information using said first information deletion protocol.

14. The projector of claim 13, wherein said projector further comprises a memory comprising instructions, said computer readable program code further comprising a series of computer readable program steps to effect:
operative if said data management protocols do not comprise a first information deletion protocol, determining if said instructions comprise a default deletion protocol;
operative if said instructions comprise a default deletion protocol, deleting said first information from said projector using said default deletion protocol.

15. The projector of claim 14, wherein said projector further comprises an information storage medium, said computer readable program code further comprising a series of computer readable program steps to effect:
writing said first information to said information storage medium;
receiving second information;
operative if said instructions do not comprise a default deletion protocol, overwriting said first information with said second information.

16. The projector of claim 13, said computer readable program code further comprising a series of computer readable program steps to effect:
determining if said first information deletion protocol comprises an autodelete function after (N) presentations of said first information;
operative if said first information deletion protocol comprises an autodelete function after (N) presentations of said first information, deleting said first information from said projector after (N) presentations of said first information.

17. The projector of claim 16, wherein said projector further comprises an information storage medium, said computer readable program code further comprising a series of computer readable program steps to effect:
writing said first information to said information storage medium;
wherein said deleting said first information step further comprises overwriting said first information with zeros.

18. The projector of claim 16, wherein said projector further comprises an information storage medium, and wherein said first information comprises a plurality of bits, said computer readable program code further comprising a series of computer readable program steps to effect:
writing said plurality of bits to said information storage medium;
wherein said deleting said first information step further comprises destroying said plurality of bits.

19. The projector of claim 11, further comprising a network interface capable of communicating with an information storage medium comprising said first information, said computer readable program code further comprising a series of computer readable program steps to effect:
determining by said network interface if said projector has access rights to said first information;
operative if said projector has access rights to said first information, retrieving said first information by said projector.

20. The projector of claim 19, wherein said information storage medium comprises said metadata, and wherein said access rights are encoded in said metadata, said computer readable program code further comprising a series of computer readable program steps to effect retrieving said metadata from said information storage medium.

21. A computer program product usable with a programmable computer processor to implement data management protocols by a projector, comprising:
computer readable program code which causes said programmable computer processor to receive first information comprising data and metadata, wherein said metadata comprises data management protocols for said first information;
computer readable program code which causes said programmable computer processor to determine if said data management protocols designate a time interval;
computer readable program code which, if said data management protocols designate a time interval, causes said programmable computer processor to determine that time interval;
computer readable program code which causes said programmable computer processor to determine the current time;
computer readable program code which causes said programmable computer processor to determine if said current time is within said time interval;
computer readable program code which, if said current time is not within said time interval, causes said programmable computer processor to not permit presentation of said first information using said projector;
computer readable program code which, if said current time is within said time interval, causes said programmable computer processor to permit presentation of said first information using said projector

22. The computer program product of claim 21, further comprising:
computer readable program code which causes said programmable computer processor to determine if said data management protocols limit the display of first information to (N) presentations;
computer readable program code which, if said data management protocols limit the display of first information to (N) presentations, causes said programmable computer processor to permit up to (N) presentations of said first information using said projector.

23. The computer program product of claim 21, further comprising:
computer readable program code which causes said programmable computer processor to determine if said data management protocols comprise a first information deletion protocol;
computer readable program code which, if said data management protocols comprise a first information deletion protocol, causes said programmable computer processor to delete said first information from said projector using said first information deletion protocol.

24. The computer program product of claim 23, wherein said projector further comprises a memory comprising instructions, further comprising:
computer readable program code which, if said data management protocols do not comprise a first information deletion protocol, causes said programmable computer processor to determine if said instructions comprise a default deletion protocol;
computer readable program code which, if said instructions comprise a default deletion protocol, causes said programmable computer processor to delete said first information from said projector using said default deletion protocol.

25. The computer program product of claim 24, wherein said projector further comprises an information storage medium, further comprising:
computer readable program code which causes said programmable computer processor to write said first information to said information storage medium;
computer readable program code which causes said programmable computer processor to receive second information;
computer readable program code which, if said instructions do not comprise a default deletion protocol, causes said programmable computer processor to overwrite said first information with said second information.

26. The computer program product of claim 23, further comprising:
computer readable program code which causes said programmable computer processor to determine if said first information deletion protocol comprises an autodelete function after (N) presentations of said first information;
computer readable program code which, if said first information deletion protocol comprises an autodelete function after (N) presentations of said first information, causes said programmable computer processor to delete said first information from said projector after (N) presentations of said first information.

27. The computer program product of claim 26, wherein said projector further comprises an information storage medium, further comprising:
computer readable program code which causes said programmable computer processor to write said first information to said information storage medium;
wherein said computer readable program code which causes said programmable computer processor to delete said first information from said projector after (N) presentations of said first information further comprises computer readable program code which causes said programmable computer processor to overwrite said first information with zeros.

28. The computer program product of claim 26, wherein said projector further comprises an information storage medium, and wherein said first information comprises a plurality of bits, further comprising:
computer readable program code which causes said programmable computer processor to write said plurality of bits to said information storage medium;
wherein said computer readable program code which causes said programmable computer processor to delete said first information from said projector after (N) presentations of said first information further comprises computer readable program code which causes said programmable computer processor to destroy said plurality of bits.

29. The computer program product of claim 11, wherein said projector further comprises a network interface capable of communicating with an information storage medium comprising said first information, further comprising:
computer readable program code which causes said programmable computer processor to determining by said network interface if said projector has access rights to said first information;
computer readable program code which causes said programmable computer processor to operative if said projector has access rights to said first information, retrieving said first information by said projector.

30. The computer program product of claim 29, wherein said information storage medium comprises said metadata, and wherein said access rights are encoded in said metadata, further computer readable program code which causes said programmable computer processor to retrieve said metadata from said information storage medium.
